(19) United States
(12) Patent Application Publication
(10) Pub. No.: US 2025/0238209 A1
(43) Pub. Date: Jul. 24, 2025

(54) MACHINE LEARNING MODEL USING COMPRESSED ACCELERATOR PROGRAMS

(71) Applicant: Silicon Laboratories Inc., Austin, TX (US)

(72) Inventors: Daniel Thomas Riedler, Escondido, CA (US); Matthew Brandon Gately, Austin, TX (US)

(21) Appl. No.: 18/421,503

(22) Filed: Jan. 24, 2024

(51) Int. Cl. G06F 8/41; G06N 20/00

(52) U.S. Cl. CPC G06F 8/41; G06N 20/00

(57) ABSTRACT

A method for executing a program includes writing a program value to a corresponding accelerator program register of accelerator program registers of an accelerator circuit according to accelerator program difference information of a compiled program. The method includes executing an accelerator program by the accelerator circuit according to program values of the accelerator program registers of the accelerator circuit. In an embodiment of the method, the compiled program corresponds to a machine learning model. The machine learning model has at least one layer and an embodiment of the method further includes searching metadata of the compiled program for compiled data associated with each layer of the machine learning model. The accelerator program difference information may be included in the metadata of the compiled program.

### BACKGROUND

### Field of the Invention

This application relates generally to electronic processing systems.

### Description of the Related Art

A conventional machine learning platform executes a machine learning model on an electronic processing system including a processor and a hardware accelerator and generates accelerator programs for execution by the hardware accelerator. For example, TensorFlow® Lite for Microcontrollers (TFLM) is an open source machine learning platform that runs machine learning models on microcontrollers and other devices using a core machine learning model that occupies only kilobytes of memory (e.g., 16 kB on a 32-bit Arm Cortex M3 processor). The machine learning platform does not require operating system support or dynamic memory allocation. Other machine learning platforms include PyTorch®, JAX, OpenCV, Keras®, Theano, Apache Spark, Caffe2, MXNet, and Amazon SageMaker®. In a typical application, execution of the machine learning model generates hundreds of hardware accelerator programs and causes the processor to write hundreds of program registers of the hardware accelerator for each hardware accelerator program, which can degrade performance of the machine learning model. Accordingly, improved techniques for accelerating execution of a machine learning model are desired.

### SUMMARY OF EMBODIMENTS OF THE INVENTION

In at least one embodiment, a method for executing a program includes writing a program value to a corresponding accelerator program register of accelerator program registers of an accelerator circuit according to accelerator program difference information of a compiled program. The method includes executing an accelerator program by the accelerator circuit according to program values of the accelerator program registers of the accelerator circuit. In an embodiment of the method, the compiled program corresponds to a machine learning model. The machine learning model has at least one layer and an embodiment of the method further includes searching metadata of the compiled program for compiled data associated with each layer of the machine learning model. The accelerator program difference information may be included in the metadata of the compiled program. In an embodiment, the method includes executing a reference kernel for each layer of the machine learning model having no corresponding compiled data in the metadata of the compiled program. The accelerator program difference information may cause the processing device to write only accelerator program registers having program values being updated from prior program values written to the accelerator program registers by an immediately preceding accelerator program in a sequence of recorded accelerator programs. In an embodiment, the processing device does not write other accelerator program registers in response to the accelerator program difference information.

In at least one embodiment, a processing system includes memory configured to store a compiled program. The compiled program includes a plurality of accelerator programs and corresponding accelerator program difference information. The processing system includes a processing device configured to execute the compiled program using the plurality of accelerator programs and the corresponding accelerator program difference information. The compiled program includes an accelerator circuit configured to execute the plurality of accelerator programs according to program values of accelerator program registers. In am embodiment, the corresponding accelerator program difference information causes the processing device to write only accelerator program registers having program values being updated from prior program values written to corresponding accelerator program registers by an immediately preceding accelerator program in a sequence of recorded accelerator programs, and the processing device does not write other accelerator program registers in response to the corresponding accelerator program difference information.

In an embodiment, a method for executing a program includes executing a compiled program on a host device and recording all accelerator programs generated thereby. The method includes storing accelerator program difference information for corresponding accelerator programs in metadata of the compiled program. In an embodiment, the method includes compressing an accelerator program recorded by the host device to generate the accelerator program difference information. The compressing may include writing values of accelerator program registers being updated from corresponding prior values of an immediately preceding accelerator program in a sequence of recorded accelerator programs to the accelerator program difference information. The program values and corresponding register addresses of unchanged accelerator program registers, unused accelerator program registers, and uninitialized arithmetic logic unit registers may be omitted from the accelerator program difference information.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exemplary integrated circuit product development system implementing a machine learning model using a hardware accelerator.

FIG. 2 illustrates a structure of an exemplary machine learning model for execution using a hardware accelerator.

FIG. 3 illustrates program register usage by an exemplary sequence of hardware accelerator programs generated by executing a machine learning model.

FIG. 4 illustrates an exemplary host processor system of the integrated circuit product development system of FIG. 1 consistent with at least one embodiment of the invention.

FIG. 5 illustrates an exemplary information and control flow for operation of the host processor system of FIG. 4 consistent with at least one embodiment of the invention.

FIG. 6 illustrates an exemplary embedded system implementing a machine learning model using a hardware accelerator consistent with at least one embodiment of the invention.

FIG. 7 illustrates exemplary pseudocode for execution of the compiled machine learning model including accelerator program difference informations consistent with at least one embodiment of the invention.

The use of the same reference symbols in different drawings indicates similar or identical items.

### DETAILED DESCRIPTION

A technique for accelerating execution of a machine learning model or other program by an embedded system includes compressing accelerator programs to reduce the number of accelerator programming operations performed during execution of a machine learning model. The technique includes using a host processing system to convert a conventional machine learning model into a compiled machine learning model including accelerator programs and metadata including compiled data. The compiled data includes accelerator program difference information indicating accelerator program registers that are changed by an accelerator program from an immediately preceding accelerator program in a sequence of accelerator programs. The compiled machine learning model executes on a system (e.g., a separate, embedded system). During execution of the compiled machine learning model, rather than writing all program registers of the accelerator for each accelerator program in the sequence of accelerator programs, the embedded device reads the accelerator program difference information and writes only those program registers of an accelerator program that are changed from the immediately preceding accelerator program in the sequence of accelerator programs. The technique results in faster runtime execution of the machine learning algorithm or other program and reduces a need for further optimizing hardware accelerated algorithms for the target processor or microcontroller. The reduction in accelerator programming operations performed reduces power consumption of a system executing the machine learning model or other program.

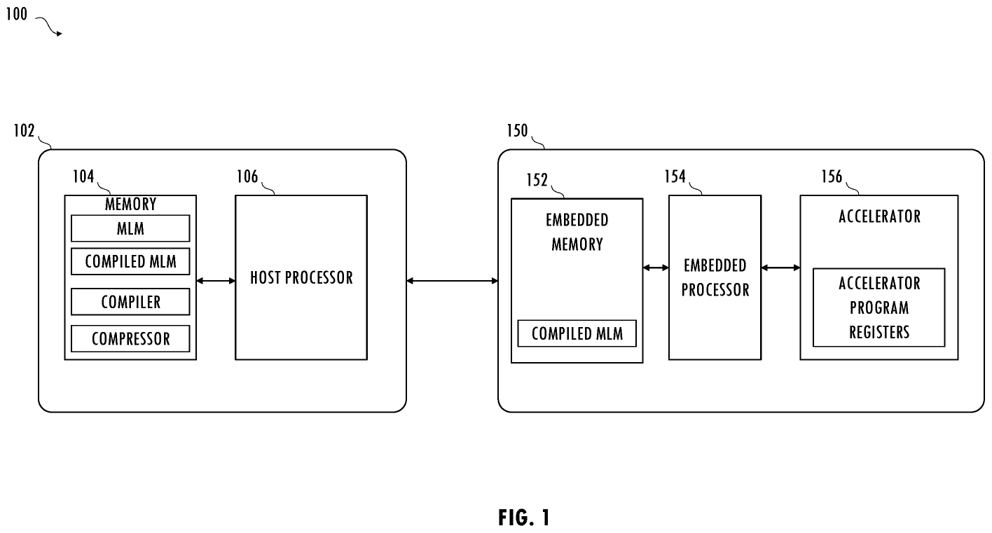

Referring to FIG. 1, product development system 100 includes host system 102 and embedded system 150. Host system 102 includes hardware and software that is used to develop application software for a target device or product (e.g., embedded system 150). Host system 102 compiles and compresses the application software to generate a compiled program, i.e., the program in an architecture-specific format (e.g., assembly language, object code, or machine code) readable by a target device (e.g., embedded processor 154). Host system 102 or other processing system writes the compiled program to a memory of the target device (e.g., embedded memory 152 of embedded system 150). For example, host processor 106 retrieves a compiler and a standard machine learning model from memory 104. Host processor 106 executes the compiler to generate a compiled machine learning model and provides the compiled machine learning model to embedded memory 152. In an embodiment, embedded system 150 includes embedded processor 154, which is a microprocessor, microcontroller, or other processing device, and accelerator 156, which is programmed using accelerator program registers and uses relative memory addressing, i.e., addresses memory using relative offsets from a predetermined base address, instead of programming absolute addresses in compiled code. In an embodiment, embedded system 150 also includes a wireless communications interface, input/output peripheral devices, or other components as needed for a target application.

In an embodiment, accelerator 156 offloads computationally intensive operations (e.g., integer multiply-accumulate (MAC) operations or complex floating point matrix multiplications and additions that are used by machine learning models) from embedded processor 154. In at least one embodiment, accelerator 156 is a matrix vector processor that includes multiple dedicated hardware arithmetic logic units (ALUs), a load/store unit, and a sequencer that handles array iteration and loop iteration. An exemplary programming interface of accelerator 156 includes program registers that are configured to start or stop accelerator 156, configure arrays of data, and configure loop operations. An exemplary accelerator is described in U.S. patent application Ser. No. 17/361,240, filed on Jun. 28, 2021, titled “Apparatus for Array Processor and Associated Methods;” U.S. patent application Ser. No. 17/361,244, filed on Jun. 28, 2021, titled “Apparatus for Processor with Macro-Instruction and Associated Methods;” U.S. patent application Ser. No. 17/361,250, filed on Jun. 28, 2021, titled “Apparatus for Memory Configuration for Array Processor and Associated Methods;” and U.S. patent application Ser. No. 17/361,257, filed on Jun. 28, 2021, titled “Apparatus for Array Processor with Program Packets and Associated Methods,” which applications are hereby incorporated by reference. Other embodiments of accelerator 156 implement other hardware accelerator architectures that are controlled by writes to accelerator program registers.

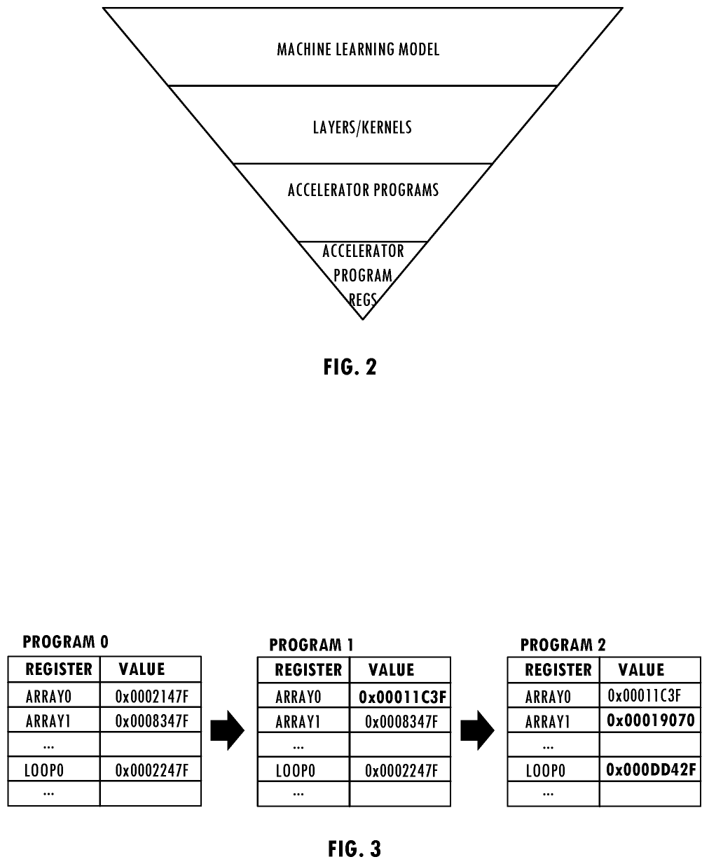

Referring to FIGS. 1 and 2, an exemplary machine learning model includes one or more layers. In an embodiment, each layer corresponds to a component that receives weighted inputs, transforms the weighted inputs using a set of linear or nonlinear operations, and passes the transformed values to a next layer. Each layer executes at least one kernel, i.e., an implementation of an operation associated with specific hardware/platform capabilities. Some operations have a one-to-one mapping from operation to kernel, while other operations use multiple kernels. In general, an operation is a mathematical operation on at least one data unit (e.g., at least one vector or multidimensional array) that produces at least one data unit as output. Operations are ‘can use other operations to define their logic.

In an embodiment, accelerator 156 executes a sequence of accelerator programs to speed up execution of a corresponding kernel. Each accelerator program in the sequence writes accelerator program registers with corresponding program values. For example, embedded processor 154 writes two hundred 32-bit program values to corresponding accelerator program registers of accelerator 156. In at least one embodiment, embedded processor 154 writes the accelerator program registers of accelerator 156 are written according to Conventional Microcontroller Software Interface Standard (CMSIS) or other technique for accessing peripheral registers. Unlike operating ALU registers, accelerator program registers are persistent during the execution of a corresponding program, i.e., the accelerator program registers do not change during the execution of a corresponding accelerator program. Therefore, embedded processor 154 needs to write only those accelerator program registers that have program values that change from the corresponding program value of the immediately previous accelerator program in the sequence.

For example, FIG. 3 illustrates a sequence of three accelerator programs. After loading and executing the first accelerator program in the sequence of accelerator programs (e.g., PROGRAM 0), the next program in the sequence is PROGRAM 1, which includes changes to values of only some of the accelerator program registers. The program value of ARRAY0 in PROGRAM 1 is 0x00011C3F, which is different from 0x0002147F, which is the program value of ARRAY) in PROGRAM 0. Meanwhile, PROGRAM 1 does not change the program values of ARRAY1 and LOOP0 from their corresponding program values in PROGRAM 0. Therefore, memory, processing cycles, and energy can be saved by writing only those accelerator program registers having values that PROGRAM 1 changes from their corresponding values of PROGRAM 0. Accelerator program difference information corresponding to PROGRAM 1 indicates a write of ARRAY0 to update its value from 0x0002147F to 0x00011C3F. PROGRAM 1 does not write corresponding program value of ARRAY1 and LOOP0, since those values do not change from PROGRAM 0 to PROGRAM 1 and an indication of a write to those accelerator program registers is omitted from the accelerator program difference information. Similarly, accelerator program difference information corresponding to PROGRAM 2 does not indicate a write of the program value for ARRAY0 since the program value of ARRAY0 in PROGRAM 2 is unchanged from its value for PROGRAM 1. In general, array values (e.g., values for dimension, size of each dimension, stride) may not change between sequential accelerator programs and therefore, need not always be rewritten by an accelerator program.

In at least one embodiment, accelerator program registers have sequential memory addresses and embedded processor 154 writes the program values to corresponding accelerator program registers using sequential memory addresses. Accelerator program difference information omits write information for at least one accelerator program register, i.e., the accelerator program difference information indicates writes for an incomplete set of accelerator program registers. Although embedded processor 154 writes the program values to corresponding accelerator program registers monotonically, the memory addresses are no longer sequential. Gaps in the memory addresses correspond to the accelerator program registers that are not being written since those program values are unchanged.

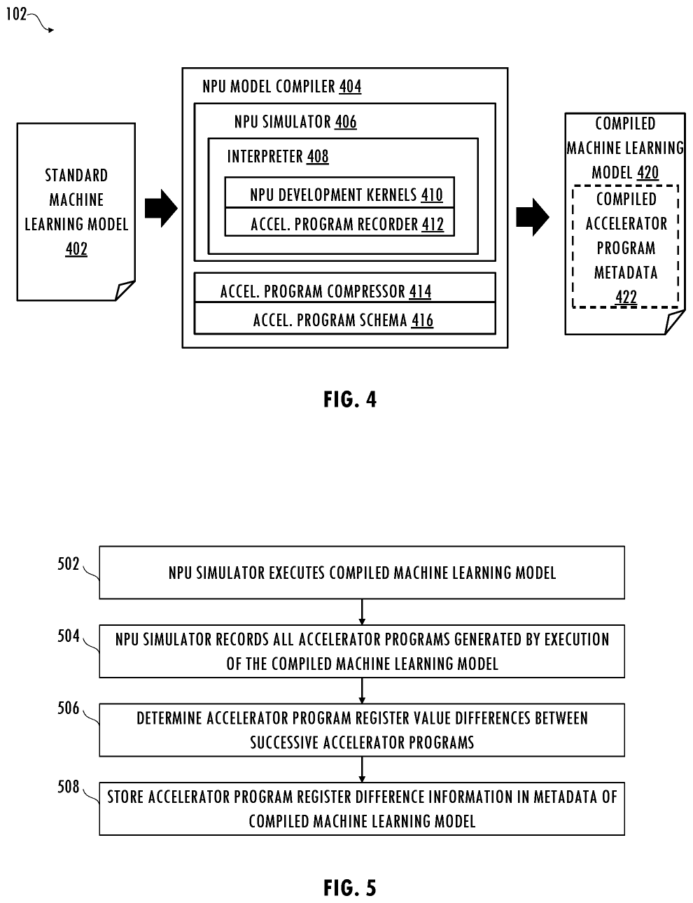

Referring to FIGS. 1, 4, and 5, rather than generating accelerator programs during program runtime and programming accelerator 156 during runtime by writing all accelerator program registers to invoke an accelerator program, host system 102 compiles standard machine learning model 402 and appends compiled accelerator programs to compiled machine learning model 420 before embedded system 150 loads compiled machine learning model 420 to embedded memory 152. In at least one embodiment, the compiled accelerator program includes only accelerator program difference information, i.e., indicators of the accelerator program registers that are changed by the accelerator program from an immediately prior accelerator program. In at least one embodiment, the accelerator difference information includes a memory address and program value pair for each accelerator program register of accelerator 156, or includes a write instruction for each accelerator program register or other indicator of a write to an accelerator program register. In an embodiment, the accelerator difference information includes a memory address (e.g., accelerator program register relative address offset) and a program value (e.g., an accelerator register program value) for each accelerator program difference and omits accelerator difference information for other accelerator program registers. In an embodiment, the memory address is:

<accelerator register absolute address>=<accelerator program registers base address>+<accelerator register relative address offset>.
In an embodiment, the corresponding metadata format is:
<list of register relative offsets><list of register values>.
For example:
<offset 0><offset 1> . . . <offset n><value 0><value 1> . . . <value n>.
However, other embodiments use other metadata formats.

In at least one embodiment, host system 102 executes neural processing unit (NPU) model compiler 404 (e.g., a Python® script) (502), which executes standard machine learning model 402 using NPU simulator 406 (e.g., an NPU Python wrapper). In general, an NPU (i.e., a tensor processing unit (TPU), neural network processor (NNP), intelligence processing unit (IPU), vision processing unit (VPU), or graph processing unit (GPU)) is a specialized circuit that implements control and arithmetic logic to execute machine learning algorithms, typically by operating on predictive models. In at least one embodiment, NPU simulator 406 invokes interpreter 408 (e.g., TensorFlow Lite for Microcontrollers), which uses NPU development kernels 410 (504). Standard machine learning model 402 executes in NPU simulator 406. NPU development kernels 410 generate any appropriate accelerator programs. NPU development kernels 410 define accelerator program register structures for corresponding algorithms and include configuration parameters (e.g., input array dimensions). The configuration parameters allow for generating accelerator programs that are specific to each layer of a machine learning model. In an exemplary embodiment, NPU development kernels 410 generate accelerator programs for executing machine learning layer algorithms that receive data input and generate data output, e.g., Convolution2D (i.e., a two dimensional convolution layer algorithm), Depthwise Convolutional2D (i.e., a depthwise two dimensional convolution layer algorithm), FullyConnected (Dense) (i.e., densely-connected neural network layer algorithm) included in Keras 3 deep learning application programming interface written in Python and capable of running on TensorFlow or other machine learning platform, or other machine learning layer algorithm for running on TensorFlow or other machine learning platform. In an embodiment, NPU development kernels 410 flag which ALU registers are initialized and constant so that those flagged registers are not eliminated from the compiled machine learning model. Accelerator program recorder 412 records which accelerator programs are generated and records which accelerator program registers are used.

After NPU simulator 406 completes execution of standard machine learning model 402, accelerator program compressor 414 compresses the accelerator programs by identifying differences in program register values between immediately successive accelerator programs (506). Accelerator program compressor 414 compresses the accelerator programs by omitting writes or indications of writes to accelerator program registers that do not have changed values from the immediately prior accelerator program in the sequence of accelerator programs and stores accelerator program difference information in metadata of the compiled machine learning model (508). In addition, accelerator program compressor 414 omits writes of indications of writes to unused accelerator program registers and uninitialized ALU registers based on flags generated by NPU simulator 406. As a result, the accelerator program difference information does not trigger writes to all accelerator program registers but rather triggers writes to incomplete sets of accelerator program registers. That is, an indication of a write to at least one accelerator program register is omitted from the accelerator program difference information corresponding to an accelerator program because the corresponding value to be written to the omitted accelerator program register is unchanged from an immediately prior corresponding value written to the omitted accelerator program register. Omission of indications of writes to those accelerator program registers in the accelerator program difference information reduces processing cycles of the accelerator program as compared to a non-compressed version of the accelerator program. Accelerator program schema 416 converts the accelerator programs to a custom format, e.g., a flatbuffer schema, and appends the accelerator program difference information to compiled machine learning model 420 in metadata. In at least one embodiment, compiled machine learning model 420 comprises a machine learning model including accelerator program difference information corresponding to a sequence of accelerator programs stored as compiled data in metadata of compiled machine learning model 420.

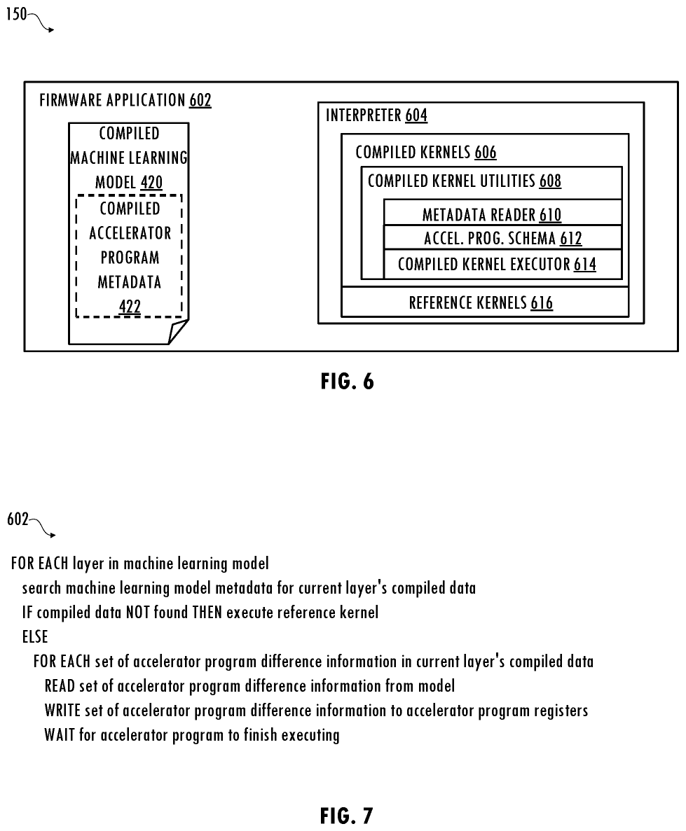

Referring to FIGS. 1, 6, and 7, host system 102 or other system writes compiled machine learning model 420, which includes compiled data in metadata, to embedded memory 152 of embedded system 150. Embedded processor 154 executes firmware application 602, which may also be stored in embedded memory 152. Since the accelerator program registers are memory-mapped and use relative addressing, the compiled machine learning model 420 generated by host system 102 can be executed by embedded system 150. Firmware application 602 performs model inference on the embedded device, i.e., the process of using a trained model to make predictions on new data. For example, compiled machine learning model 420 has been trained to recognize certain patterns relevant to the target application and compiled machine learning model 420 applies that knowledge to new data and makes predictions about that new data.

In an embodiment of embedded system 150, during model inference, for each layer of compiled machine learning model 420, interpreter 604 initializes accelerator 156, e.g., sets pointers to registers and data (e.g., sets array base addresses with kernel input/output tensor buffers). In an embodiment of embedded system 150, interpreter 604 (e.g., TensorFlow Lite for Microcontrollers) runs compiled kernels 606 of compiled machine learning model 420. For each layer in compiled machine learning model 420, compiled kernel executor 614 searches compiled accelerator program metadata 422 for compiled data associated with the current layer. If compiled kernel executor 614 finds no compiled data for a current layer, then accelerator 156 is not used by the current layer and compiled kernel executor 614 executes a kernel found in reference kernels 616. Reference kernels 616 implement kernel algorithms using embedded processor 154 (i.e., using software only) and do not use any hardware accelerator and do not generate accelerator programs. If compiled kernel executor 614 finds compiled data for the current layer, then compiled kernel executor 614 runs compiled kernels 606 associated with the current layer. For example, compiled kernel executor 614 uses compiled kernels utilities 608, e.g., metadata reader 610, to parse compiled information and associated metadata from compiled machine learning model 420 according to accelerator program metadata schema 612. For each set of accelerator program difference information, compiled kernels utilities 608 reads the accelerator program difference information from compiled machine learning model 420 (e.g., from compiled accelerator program metadata 422) and compiled kernel executor 614 writes the changed program values to the corresponding accelerator program registers of accelerator 156. Interpreter 604 causes the accelerator circuit to execute each accelerator program in a sequence of accelerator programs according to contents of the accelerator program registers. After writing the accelerator program difference information, interpreter 604 issues a start command (e.g., a write to an accelerator register that triggers execution) to accelerator 156.

In at least one embodiment, host system 102 and embedded system 150 substantially compress execution of a machine learning model using compiled data including accelerator programs and corresponding accelerator program difference information. By only performing writes of changed program values needed to update accelerator program registers instead of writing all accelerator program registers for each accelerator program, instruction throughput of the embedded system substantially improves. For example, execution of a tiny machine learning benchmark program, “visual_wake_words,” is compressed by approximately 90%. Thus, techniques for compressing execution of a program have been described.

Structures described herein may be implemented using software executing on a processor (which includes firmware) or by a combination of software and hardware. Software, as described herein, may be encoded in at least one tangible (i.e., non-transitory) computer readable medium. As referred to herein, a tangible computer-readable medium includes at least a disk, tape, or other magnetic, optical, or electronic storage medium.

The description of the invention set forth herein is illustrative and is not intended to limit the scope of the invention as set forth in the following claims. For example, while the invention has been described in an embodiment in which a machine learning model is executed, one of skill in the art will appreciate that the teachings herein can be utilized with other types of programs that use accelerator hardware having memory mapped program registers that are persistent during execution of an accelerator program. The terms “first,” “second,” “third,” and so forth, as used in the claims, unless otherwise clear by context, are to distinguish between different items in the claims and do not otherwise indicate or imply any order in time, location or quality. For example, “a first received signal,” and “a second received signal,” do not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for executing a program, the method comprising:
writing a program value to a corresponding accelerator program register of accelerator program registers of an accelerator circuit according to accelerator program difference information of a compiled program; and
executing an accelerator program by the accelerator circuit according to program values of the accelerator program registers of the accelerator circuit.

2. The method as recited in claim 1 wherein the compiled program corresponds to a machine learning model, the machine learning model having at least one layer and the method further comprises:
searching metadata of the compiled program for compiled data associated with each layer of the machine learning model, the accelerator program difference information being included in the metadata of the compiled program; and
executing a reference kernel for each layer of the machine learning model having no corresponding compiled data in the metadata of the compiled program.

3. The method as recited in claim 1
wherein the accelerator program difference information causes the processing device to write only accelerator program registers having program values being updated from prior program values written to the accelerator program registers by an immediately preceding accelerator program in a sequence of recorded accelerator programs, and
wherein the processing device does not write other accelerator program registers in response to the accelerator program difference information.

4. The method as recited in claim 1 further comprising:
executing the compiled program on a host device and recording all accelerator programs generated thereby;
compressing a recorded accelerator program to generate the accelerator program difference information; and
storing the accelerator program difference information in metadata of the compiled program.

5. The method as recited in claim 4 wherein the compressing comprises:
writing an indication of the corresponding accelerator program register to the accelerator program difference information, the program value being updated from a prior program value written to the corresponding accelerator program register by an immediately preceding accelerator program in a sequence of recorded accelerator programs; and
omitting from the accelerator program difference information, an indication of any accelerator program register of the accelerator program registers unchanged by the immediately preceding accelerator program in the sequence of recorded accelerator programs, any unused accelerator program registers, and any uninitialized arithmetic logic unit registers.

6. A processing system comprising:
memory configured to store a compiled program, the compiled program including a plurality of accelerator programs and corresponding accelerator program difference information;
a processing device configured to execute the compiled program using the plurality of accelerator programs and the corresponding accelerator program difference information; and
an accelerator circuit configured to execute the plurality of accelerator programs according to program values of accelerator program registers.

7. The processing system as recited in claim 6
wherein the corresponding accelerator program difference information causes the processing device to write only accelerator program registers having program values being updated from prior program values written to corresponding accelerator program registers by an immediately preceding accelerator program in a sequence of recorded accelerator programs, and
wherein the processing device does not write other accelerator program registers in response to the corresponding accelerator program difference information.

8. The processing system as recited in claim 6 wherein the accelerator program registers are memory-mapped and are accessible using relative addressing.

9. The processing system as recited in claim 6
wherein the compiled program corresponds to a machine learning model, the machine learning model having at least one layer, and
wherein the plurality of accelerator programs correspond to at least one kernel of the at least one layer.

10. The processing system as recited in claim 6
wherein the compiled program corresponds to a machine learning model, the machine learning model having at least one layer, and
wherein the corresponding accelerator program difference information is included in metadata of the compiled program and the corresponding accelerator program difference information causes the processing device to execute a reference kernel for each layer of the machine learning model having no corresponding compiled data in the metadata of the compiled program.

11. The processing system as recited in claim 6 further comprising:
host memory configured to store the compiled program; and
a host processing system configured to generate the corresponding accelerator program difference information by executing the compiled program and recording accelerator programs generated by execution of the compiled program.

12. The processing system as recited in claim 11 wherein the host processing system is further configured to store the corresponding accelerator program difference information in metadata of the compiled program.

13. The processing system as recited in claim 11 wherein the host processing system is further configured to generate the corresponding accelerator program difference information by:
writing indications of accelerator program registers being updated from prior values of an immediately preceding accelerator program of the plurality of accelerator programs to the corresponding accelerator program difference information,
wherein writes to unchanged accelerator program registers, unused accelerator program registers, and uninitialized arithmetic logic unit registers are omitted from the corresponding accelerator program difference information.

14. The processing system as recited in claim 11 wherein the host processing system is further configured to record accelerator program registers used by the compiled program and to identify any initialized and constant arithmetic logic unit registers.

15. The processing system as recited in claim 6 wherein program values of the accelerator program registers do not change during execution of each accelerator program of the plurality of accelerator programs.

16. A method for executing a program, the method comprising:
executing a compiled program on a host device and recording all accelerator programs generated thereby; and
storing accelerator program difference information for corresponding accelerator programs in metadata of the compiled program.

17. The method as recited in claim 16 further comprising:
compressing an accelerator program recorded by the host device to generate the accelerator program difference information,
wherein the compressing comprises writing values of accelerator program registers being updated from corresponding prior values of an immediately preceding accelerator program in a sequence of recorded accelerator programs to the accelerator program difference information; and
wherein program values and corresponding register addresses of unchanged accelerator program registers, unused accelerator program registers, and uninitialized arithmetic logic unit registers are omitted from the accelerator program difference information.

18. The method as recited in claim 16 further comprising:
executing the compiled program on a processing device,
wherein the compiled program corresponds to a machine learning model, the machine learning model having at least one layer, and
wherein executing the compiled program on the processing device comprises:
executing a reference kernel for each layer of the machine learning model having no corresponding compiled data in the metadata of the compiled program.

19. The method as recited in claim 16 further comprising:
executing the compiled program on a processing device,
wherein the compiled program corresponds to a machine learning model, the machine learning model having at least one layer, and
wherein executing the compiled program on the processing device comprises:
searching the metadata of the compiled program for compiled data associated with each layer of the machine learning model.

20. The method as recited in claim 16 further comprising:
executing the compiled program on a processing device,
wherein the compiled program corresponds to a machine learning model, the machine learning model having at least one layer,
wherein executing the compiled program on the processing device comprises:
for each layer of the machine learning model:
writing changed accelerator program register values for the layer, to corresponding accelerator program registers of a plurality of accelerator program registers, according to the accelerator program difference information; and
executing an accelerator program of the corresponding accelerator programs associated with the layer according to contents of the plurality of accelerator program registers.
